(19) United States
(12) Patent Application Publication
(10) Pub. No.: US 2015/0173864 A1
(43) Pub. Date: Jun. 25, 2015

(54) ABUTMENT ASSEMBLY FOR DENTAL IMPLANTS

(71) Applicant: POMODENT DENTAL, LTD, Holon (IL)

(72) Inventor: Shlomo Pomeranitz, Holon (IL)

(21) Appl. No.: 14/414,115

(22) PCT Filed: Jul. 10, 2013
(86) PCT No.: PCT/IL2013/050589

§ 371 Date: Jan. 11, 2015

(30) Foreign Application Priority Data
Jul. 12, 2012 (IL) 220940

(51) Int. Cl. A61C 8/00

(52) U.S. Cl. CPC A61C 8/0068; A61C 8/0022; A61C 8/006; A61C 8/0074

(57) ABSTRACT

An abutment assembly for dental implants comprising only prefabricated components, which comprises an interface element which is insertable within the interior of an endosseous implant and positionable in abutting relation with the endosseous implant; a coupling element connected to the interface element; an abutment which is engageable with the coupling element and coronally spaced from the interface element, and a screw threadedly engageable with the implant and securable to the abutment, such that one or more dimensions of the coupling element are selectable in accordance with dimensions of an extraction socket associated with the implant, and a disposition of the abutment with respect to the implant is intraorally adjustable.

### FIELD OF THE INVENTION

The present invention relates to the field of dental implants. More particularly, the invention relates to a prefabricated abutment assembly for dental implants.

### BACKGROUND OF THE INVENTION

An endosseous implant for replacing a tooth root is adapted to support and receive a dental prosthetic piece. An implant has an elongated root shape, with a surface area designed to promote good attachment to the jawbone. Most implants are made of titanium or of a titanium alloy, due to the biocompatibility and high rate of osseointegration, i.e. the physiological process of fusing with a living bone, of such a material.

The position of a three-dimensional implant has to be accurately recorded by means of an elastomeric impression material in order to transfer the position of an implant in the jaw onto a plaster model and to achieve an accurately fitting prosthesis. One accepted way of forming the impression is by screwing a coping, or a post, to an implant abutment by a close fit according to the pick-up technique whereby an open tray having an opening for exposing the coronal end of the coping is positioned along the dental arch. The impression material is injected within the tray so that after hardening, the copings are unscrewed and are removed together with the impression. Implant analogs in the impression are connected to the copings in order to fabricate a cast.

A transmucosal abutment made of e.g. titanium or zirconia, which is attached to the implant and provides access for the head of a connecting screw that stabilizes the abutment on the implant, is generally custom made, for example if the implant requires an angle of correction greater than 15 degrees, in order to achieve the natural dentition. The abutment is customized by a time consuming procedure by which it is adjusted using dental tools and then digitized by a scanner, after which a crown model is generated using CAD techniques and finally a physical crown is milled out of a dental material such as ceramic, composite or metal.

Prior art implants generally have a hex shaped seat for receiving and resisting rotation of the abutment. Due to its hex shaped configuration, the abutment received in the seat has thin walls which do not sufficiently absorb lateral masticatory forces that sometimes are as high as 80 kg/cm₂, often leading to failure of the connecting screw.

One piece prefabricated abutments that are integrally formed with the implant and shorten the abutment preparation time are commercially available; however, these abutments nevertheless need to be machined intraorally in order to accurately record the orientation of the implant by means of the impression.

Intraoral machining has been found to be deficient in terms of localized heating, which can lead to damage to the titanium implant and to a neighboring tooth, and cumbersome machine operations.

It is an object of the present invention to provide a prefabricated abutment assembly for dental implants that reduces the preparation time, discomfort and costs normally associated with prior art devices.

It is another object of the present invention to provide a prefabricated abutment assembly for dental implants that achieves the natural dentition without having to be machined.

It is another object of the present invention to provide a dental implant that enables the abutment to be more structurally strong than prior art devices.

Other objects and advantages of the invention will become apparent as the description proceeds.

### SUMMARY OF THE INVENTION

The present invention provides an abutment assembly for dental implants comprising only prefabricated components, said abutment assembly comprising an interface element insertable within the interior of, and positionable in abutting relation with, an endosseous implant, a coupling element connected to said interface element, an abutment engageable with said coupling element and coronally spaced from said interface element, and a screw threadedly engageable with said implant and securable to said abutment, wherein one or more dimensions of said coupling element are selectable in accordance with dimensions of an extraction socket associated with said implant and a disposition of said abutment with respect to said implant is intraorally adjustable.

In one aspect, the abutment is rotatable with respect to the coupling element and about an implant axis when being adjusted intraorally. A central annular member of the coupling element protruding coronally from an apical member thereof is receivable in a complementary recess of the abutment, the abutment being rotatable about the central annular member of the coupling element when being adjusted intraorally.

In one aspect, a height of the coupling element from a coronal edge of the central annular member to an apical edge of the apical member thereof is selected to be substantially equal to the depth of the extraction socket.

In one aspect, the coupling element is adhesively connected to the interface element, or alternatively, is fused to, or is integral with, the interface element.

In one aspect, the abutment assembly further comprises a dental structure which is releasably attachable to, and similarly configured as, a coronal end of the abutment.

In one aspect, the screw is receivable in a central apically extending cavity formed in the abutment, said cavity coinciding with a central cavity formed in the interface element and in the coupling element. The cavity formed in the abutment is also formed with a shoulder for contacting and limiting the travel of a coronal head of the screw while apical threading of the screw is being engaged with internal threading of the implant.

In one aspect, a protruding element of the interface element receivable in a complementary seat of the implant is hex shaped or square shaped.

The present invention is also directed to a kit comprising the prefabricated components of the abutment assembly including a plurality of differently dimensioned coupling elements and abutments.

In one aspect, the kit further comprises a plurality of copings, each of which is releasably attachable to, and similarly configured as, a coronal end of a corresponding abutment.

In one aspect, the kit further comprises one or more measuring tools for measuring a corresponding intraoral dimension and for selecting thereby one of the plurality of differently dimensioned coupling elements and one of the plurality of differently dimensioned abutments.

In one aspect, the kit further comprises one or more demo dies, each of which comprising an abutment portion having the same size and shape as the coping and being insertable therewithin to facilitate production of a master model, an implant portion, and an intermediate portion extending from said implant portion to said abutment portion.

The present invention is also directed to a dental implant, comprising a core that is gradually reduced in diameter from a coronal portion to an apical end and spiral threads protruding radially from said core, wherein said threads are obliquely disposed such that they point apically at an angle with respect to a transverse plane ranging from 15 to 25 degrees, in order to induce increased bone density and osseointegration in the vicinity of said threads as a result of pressure applied thereby onto the adjacent bone tissue.

In one aspect, the threads are arranged such that a combined width of the core and of a thread at a given implant depth defines a uniform implant width that is substantially equal to the implant width at any other implant depth between the coronal portion and the apical end, for facilitating anchorage into cancellous bone.

In one aspect, the implant has a square shaped seat in which is receivable a complementary protruding element of an abutment, said seat being accessible to said protruding element via the interior of the coronal portion.

### BRIEF DESCRIPTION OF THE DRAWINGS

In the drawings:

FIG. 1 is an exploded view of a dental abutment assembly according to one embodiment of the present invention;

FIG. 2 is a labial view of an assembled implant assembly that comprises the abutment assembly of FIG. 1;

FIG. 3 is a medial cross sectional view of the implant assembly of FIG. 2 with an abutment having a 0 degree angulation, cut along plane A-A;

FIG. 4 is a front view of a collar height measuring tool;

FIG. 5 is a cross sectional view of the tool of FIG. 4, cut along plane B-B;

FIG. 6 is a front view of another collar height measuring tool;

FIG. 7 is a front view of a protractor tool for measuring the angle of a dental structure with respect to a frontal plane;

FIG. 8 is a side view of the protractor tool of FIG. 7;

FIG. 9 is a medial cross sectional view of an implant assembly with an abutment having a 12 degree angulation, shown without a coping;

FIG. 10 is a medial cross sectional view of an implant assembly with an abutment having a 24 degree angulation;

FIG. 11 is an exploded view of a dental abutment assembly according to another embodiment of the invention;

FIG. 12 is a perspective view from the apical end of an abutment used in conjunction with the abutment assembly of FIG. 11;

FIG. 13 is a top view of a coupling element used in conjunction with the abutment assembly of FIG. 11;

FIG. 14 is a medial view of an assembled implant assembly that comprises the abutment assembly of FIG. 11;

FIG. 15 is a cross sectional view of the implant assembly of FIG. 14, cut about plane C-C;

FIG. 16 is an enlargement of FIG. 15, showing Detail D;

FIG. 17 is a schematic illustration of a kit containing a plurality of prefabricated components, according to an embodiment of the present invention;

FIG. 18 is a palatal view of an analog contained in the kit of FIG. 17, for use in fabricating a permanent crown;

FIG. 19 is a palatal view of a temporary crown form contained in the kit of FIG. 17;

FIG. 20 is a perspective view of an implant for use in replacing anterior teeth, according to one embodiment of the invention;

FIG. 21 is a medial cross sectional view of the implant of FIG. 20;

FIG. 22 is a plan view of the implant of FIG. 20;

FIG. 23 is a transverse cross sectional view of square and hex shaped abutments that are superimposed one on top of the other while the bores are aligned, showing the improved force absorption ability of a square shaped abutment relative to a hex shaped abutment;

FIG. 24 is a medial cross sectional view of an implant assembly comprising the implant of FIG. 20;

FIG. 25 is a perspective frontal view of an implant assembly for use in replacing posterior teeth;

FIG. 26 is a medial cross sectional view of the implant assembly of FIG. 25, cut along plane G-G;

FIG. 27 is an exploded view of an abutment assembly for use in conjunction with the implant assembly of FIG. 25;

FIG. 28 is a perspective view of a demo die insertable in the coping of FIG. 27, for facilitating production of a master model;

FIG. 29 is a medial view of a one piece implant-abutment fixture for replacing an anterior tooth;

FIG. 30 is a frontal view of an implant assembly comprising the fixture of FIG. 29 and a coping which is fitted on the fixture;

FIG. 31 is a medial view of the assembly of FIG. 30;

FIG. 32 is a frontal cross sectional view of the assembly of FIG. 30, cut along plane H-H;

FIG. 33 is an exploded view of an abutment assembly in medial view, according to another embodiment of the invention; and

FIG. 34 is a frontal view of an implant assembly comprising the abutment assembly of FIG. 33.

### DETAILED DESCRIPTION OF PREFERRED EMBODIMENTS

The present invention is an abutment assembly for dental implants made of prefabricated and mass producible components, by which the time and discomfort associated with implant related operations until a prosthetic piece is coupled to the abutment assembly are significantly reduced with respect to prior art devices.

The mass producible abutment assembly of the present invention allows a prosthodontist to perform in a single session an implantation operation, attachment of a suitably angularly configured abutment to the implant, a coping attachment operation, an impression pick-up operation, and a temporary crown attachment operation. While all these operations have been able to be performed heretofore within an interval of more than a month, the use of the implant assembly of the present invention dramatically reduces the waiting time of a patient.

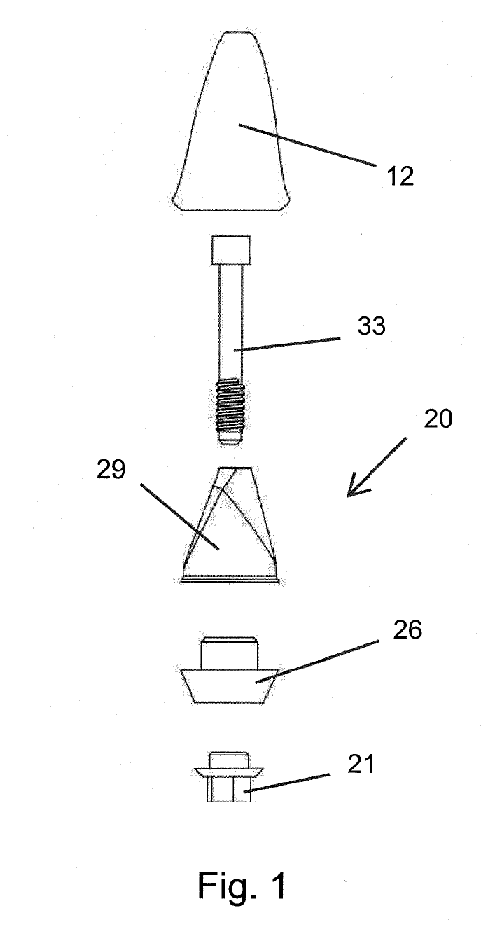

FIG. 1 illustrates an exploded view of an intraorally adjustable abutment assembly, according to one embodiment of the present invention, which is generally designated by numeral 20. Abutment assembly 20 comprises interface element 21 insertable within the interior of an implant, coupling element 26 adhesively connectable to interface element 21, abutment 29 adhesively connectable to coupling element 26, and main screw 33 for engaging the inner threading of the implant, to provide an immobilized implant assembly. A coping 12 is releasably fittable over abutment 29 in order to prepare an impression. All of these components of abutment assembly 20 are prefabricated, allowing the abutment assembly to be quickly assembled with components having selected dimensions and angulation.

As a crown is attached to the abutment assembly and the abutment assembly is attached to the implant, the orientation of the implant influences the orientation of the crown, or any other dental structure attached to the abutment assembly. While a prior art abutment, e.g. a one piece prefabricated abutment, has to be machined intraorally by a cumbersome operation that is liable to risk the integrity of the implant or of a neighboring tooth in order to achieve proper dentition, abutment assembly 20 of the present invention is able to be adjusted intraorally, as will be described hereinafter, so as to obviate intraoral machining.

An extraction socket is formed in the gingiva as a result of implantation within the jawbone. After implantation, a measuring tool is used to measure the extraction socket dimensions, in order to provide the prosthodontist with the needed information for accurately selecting the abutment assembly configuration.

For example, a periodontal probe may be used to measure the collar height between the implant platform, i.e. the coronal end of the implant on which abutment assembly 20 rests, and the gingival margin, i.e. the coronal end of a gingival portion laterally adjacent to the extraction socket. Measuring this collar height helps to select coupling element 26, the height of which should correspond to the measured collar height.

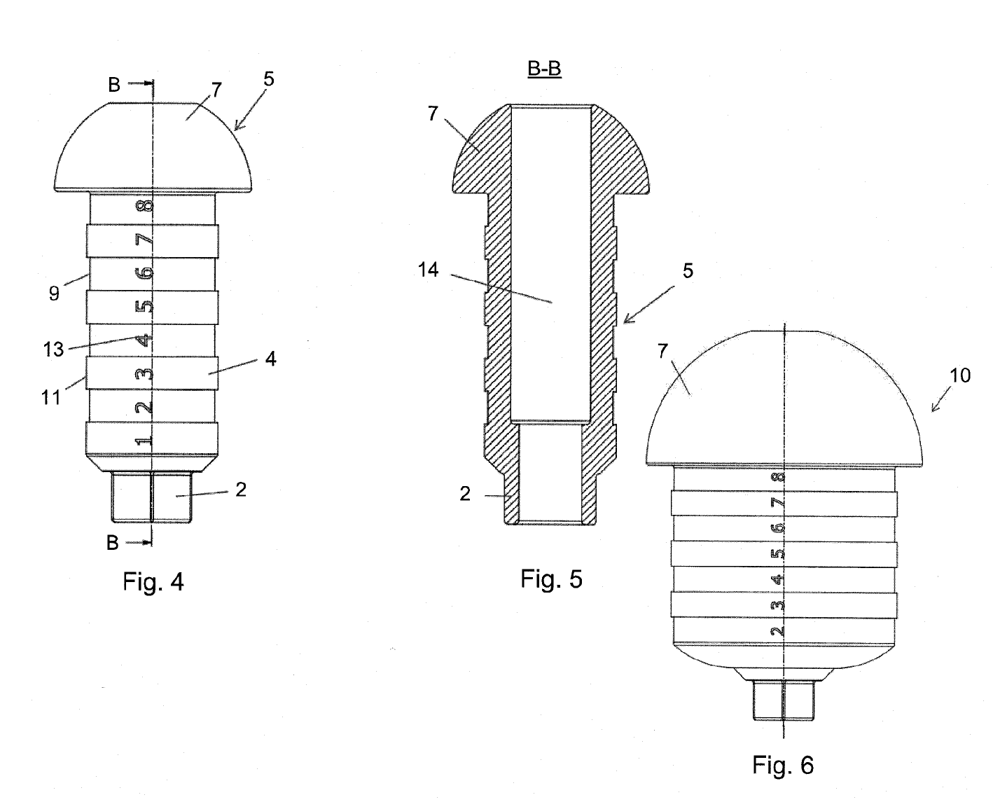

Alternatively, a measuring tool shown in FIG. 4-6 may be used to select the coupling element vertical dimension.

FIG. 4 illustrates collar height measuring tool 5. Measuring tool 5 comprises a apical hex shaped securing portion 2 for insertion within the interior of the implant, a coronal cap 7, e.g. with a truncated hemispherical shape, and an elongated measuring section 4 interposed between cap 7 and securing portion 2. Measuring section 4 has a plurality of visible, evenly spaced gradations 9 for indicating the collar height above the implant platform. Each gradation 9 may be notched or recessed, as shown, defining uniformly sized non-recessed portions 11 therebetween, e.g. having a height of 1 mm, on which is indicated an indicium 13 representing the given height above the implant platform. Alternatively, each gradation may be a visually perceptible marking applied to the outer surface of measuring section 4.

As shown in FIG. 5, measuring tool 5 may be formed with a central cavity 14 through which a screw may be introduced for engagement with the internal threading of the implant.

FIG. 6 illustrates a measuring tool 10 that is identical to tool 5 of FIG. 4 but of a greater diameter and more thickened. Thus coronal cap 7 has a predetermined lateral dimension for measuring the lateral dimension of the extraction socket. Measuring tool 10 has a lateral dimension, for example, of 7 mm, 8 mm or 9 mm while measuring tool 5 has a lateral dimension of 4 mm.

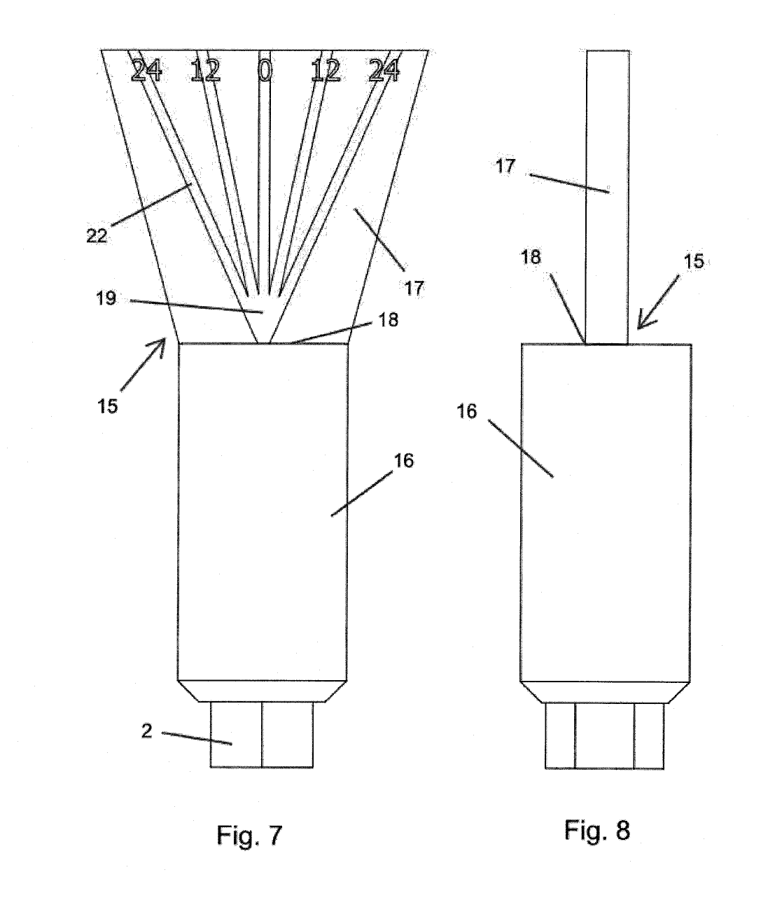

Protractor tool 15 shown in FIGS. 7 and 8 may be used to measure the angle of the jawbone as indicated by a dental structure, e.g. a tooth, with respect to a medial plane. Tool 15 has a apical hex shaped securing portion 2 for insertion within the interior of the implant, a coronal measuring section 17 having a uniform thickness but of varying width that increases in a coronal direction, and a central positioning element 16. Measuring section 17 is positioned at an intermediate portion of positioning element 16, and is provided, e.g. imprinted or engraved, on each buccal and lingual side thereof with a plurality of angularly spaced indicators 22 that converge at portion 19 near the vicinity of interface 18 between positioning element 16 and measuring section 17. A suitably configured abutment may be selected once the angulation of the neighboring dental structures is determined. If so desired, positioning element 16 may be provided with a plurality of spaced gradations for measuring the collar height above the implant platform. Protractor tool 15 may also be formed with a central cavity, to allow a screw to be introduced therewithin and to be engaged with the implant.

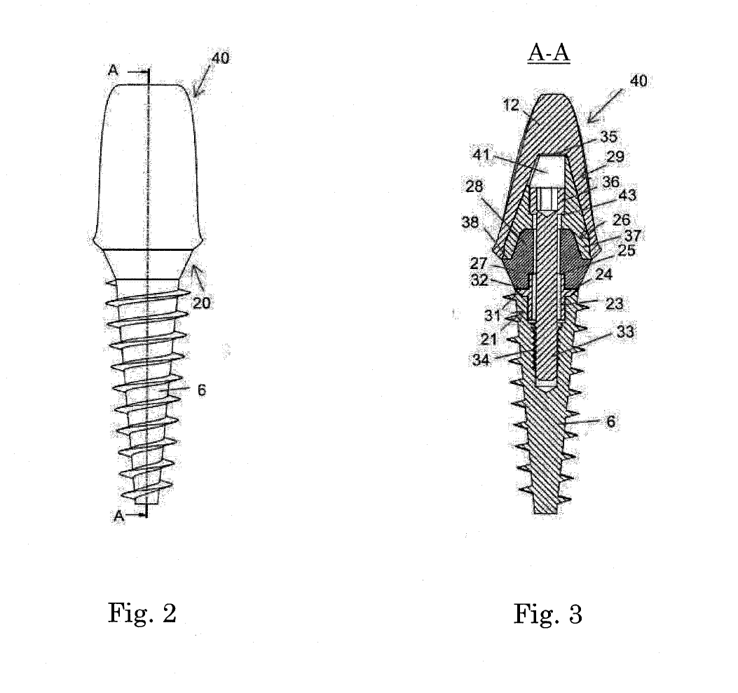

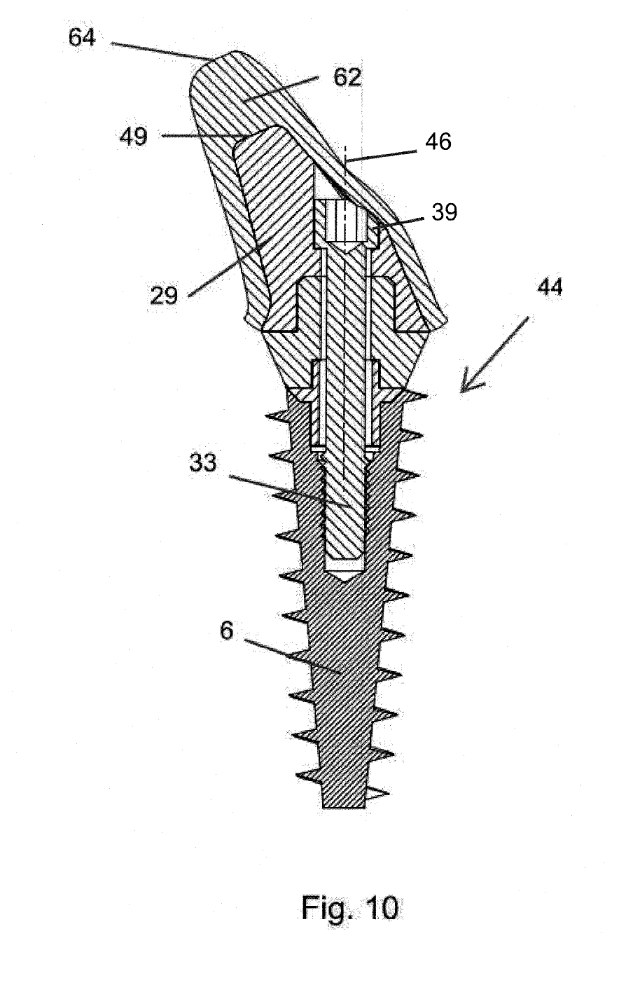

FIG. 2 illustrates a labial view of an assembled implant assembly 40 that includes implant 6 to which abutment assembly 20 is attached. Implant 6 may be a conventional implant having a hex shaped seat, or may be have a novel configuration, as will be described hereinafter. The abutment assembly, which is adapted to be received in the implant seat, is shown to have a 0 degree angulation with respect to a frontal plane coinciding with implant axis 46 (FIG. 10).

With reference to FIG. 1 and FIG. 3, which illustrates a medial cross sectional view of implant assembly 40, interface element 21 made of titanium or of a titanium alloy is provided with a vertically oriented, axially extending barrel 23 and an annular projection 24 radially extending from an intermediate portion of the outer surface of barrel 23. Projection 24 has a terminal sloping surface 31 for contacting a complementary inner surface of coronal end 8 of implant 6 within the implant interior.

Coupling element 26, which may be made of zirconia or any other substance that is resistant to corrosion, has an apical member 27 of inverted frusto-conical shape extending obliquely from interface element 21, and apical planar surfaces 25 and 32 of member 27 that are positionable in abutting relation with the coronal surface of barrel 23 and annular projection 24, respectively, and adhesively connectable therewith. A surface 38 transversally extends from the coronal end of member 27, and a central annular and frusto-conical member 28 extending coronally from surface 38. The height of coupling element 26 is selected to be substantially equal to the depth of the extraction socket. The maximum diameter of coupling element 26 may be selected in accordance with the lateral dimension of the extraction socket.

Abutment 29 has a tooth shaped configuration arranged such that its coronal planar surface 35 has a significantly narrower dimension than the dimension of the annular apical contact element 37 in abutting relation with surface 38 of coupling element 26. Abutment 29 is recessed to allow contact element 37 to be engageable and adhesively connectable with member 28. A central, vertically extending cavity 41 through which is introduced main screw 33 is formed in abutment 29, and coincides with the central cavity formed in interface element 21 and coupling element 26. Cavity 41 is formed with a shoulder 43 for contacting and limiting the travel of coronal polygonal head 36 of main screw 33 while the main screw apical threading 34 is being engaged with the threading of implant 6.

After determining that a dental structure attachable to abutment assembly 20 will not be aligned with neighboring dental structures, the prosthodontist or any other dental practitioner is advantageously able to rotate abutment 29 with respect to coupling element 26 and about the axis of implant 6 until the abutment is correctly aligned and good dentition is achieved.

After being suitably positioned, coupling element 26 is adhesively connected to interface element 21 and to abutment 29, preferably by means of an adhesive agent that is resistant to saliva or other moisture found in the oral cavity, such as Zirconium Cem manufactured by GDF Private Label Chemistry, Rosbach, Germany or a metal primer for effecting a metal-resin bond. Main screw 33 is then received in cavity 41 of abutment 29 and then engaged with implant 6.

Alternatively, the abutment assembly may comprise a coupling element that is fused together with the interface element preferably by a sintering operation, or integrally formed together, so that this combined member will be both supported by implant 6 and coupled to implant 29.

In order to fit over abutment 29, coping 12 has a central cavity which is formed complementarily to abutment 29.

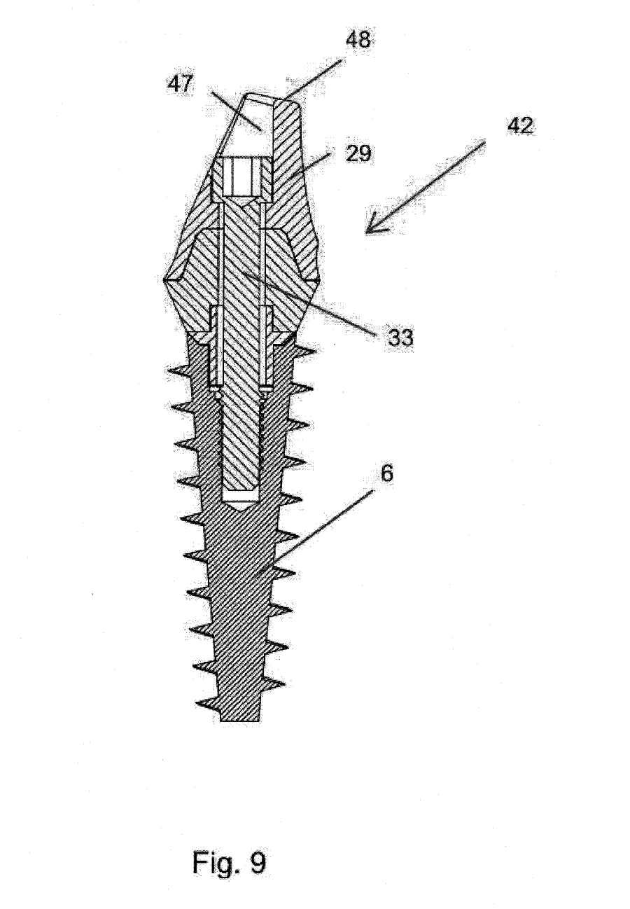

FIG. 9 illustrates a medial cross sectional view of an implant assembly 42 shown without a coping. Implant assembly 42 comprises an abutment 29 having a 12 degree angulation configured such that its coronal planar surface 48 is disposed at an angle of 12 degrees with respect to the axis of implant 6 and main screw 33. The abutment angulation is chosen to correspond to the angular disposition of the jawbone or of neighboring teeth with respect to a medial plane. Although surface 48 is angled with respect to main screw 33, main screw 33 is nevertheless introduced directly into engagement with the threading of implant 6 via central cavity 47 without having to be tilted.

FIG. 10 illustrates a medial cross sectional view of an implant assembly 44 comprising an abutment 29 having a 24 degree angulation configured such that its coronal planar surface 49 is disposed at an angle of 24 degrees with respect to axis 46 of implant 6 and main screw 33. Coronal surface 64 of coping 62 is substantially parallel to surface 49. In order to accommodate the configuration of coping 62, head 39 of main screw 33 is machined, e.g. chamfered, extraorally before being introduced to the oral cavity.

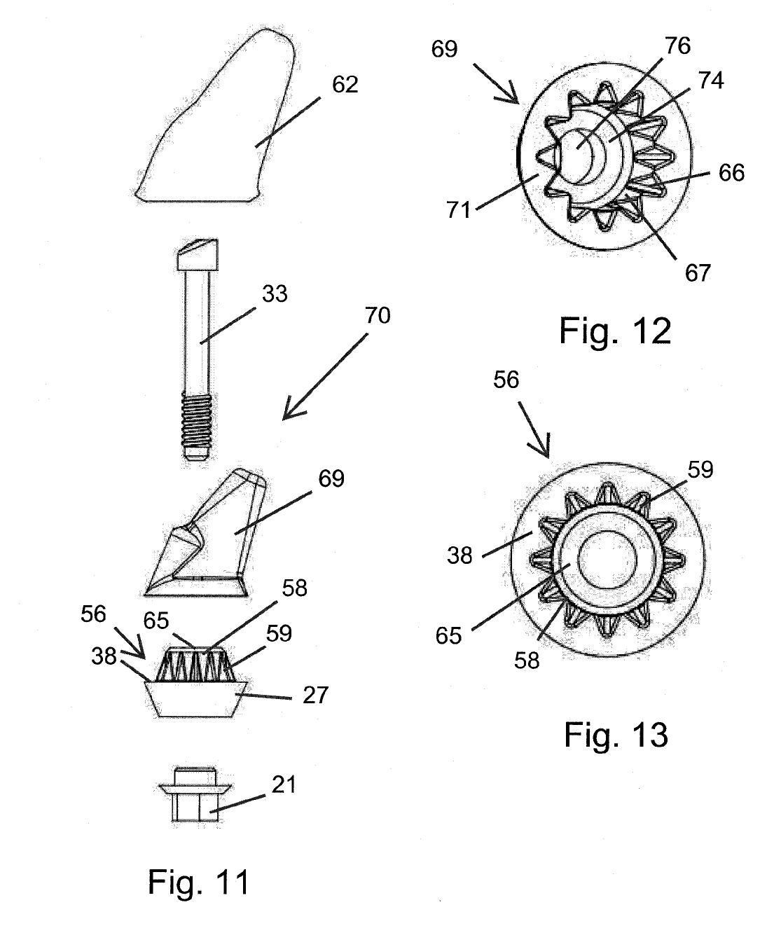

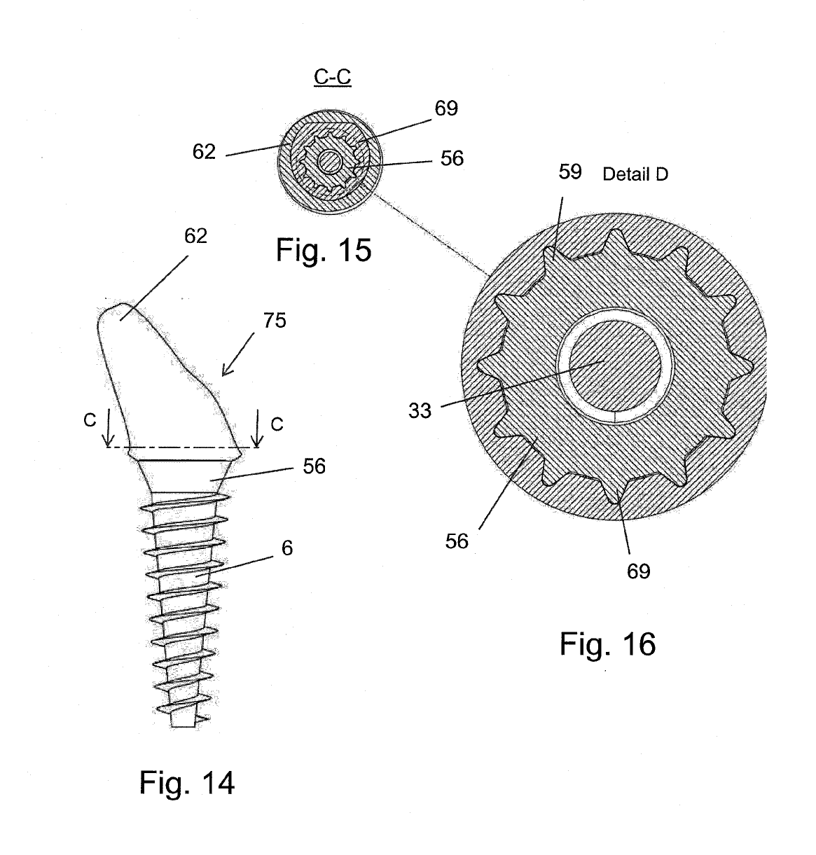

In another embodiment of the invention as shown in FIGS. 11-16, abutment assembly 70 having a 24 degree angulation with respect to a frontal plane coinciding with the implant axis comprises a coupling element 56 which is formed with a plurality of circumferentially spaced teeth 59 that protrude radially outwardly from its frusto-conical member 58. Each tooth 59 extends corononally from surface 38 to surface 65. Protruding teeth 59 are adapted to be engaged with complementary circumferentially spaced recessed elements 66 formed in hollow contact element 67 of abutment 69, in order to prevent unwanted rotation and loosening of abutment 69 during mastication. Recessed elements 66 extend coronally from circular, planar apical surface 71 of abutment 69, which is placeable in abutting relation with surface 38 of coupling element 56, to annular surface 74, which is placeable in abutting relation with coronal annular surface 65 of coupling element 56. Main screw 33 is introducible within central cavity 76 of abutment 69, passing through the interior of contact element 67 and also through the interior of coupling element 56 and interface element 21. The medial cross section of implant assembly 75 is the same as that of implant assembly 44 shown in FIG. 10.

Protruding teeth 59 may be triangularly shaped in plan view such that the base of one tooth is contiguous with the base of another tooth at the vicinity of surface 38 of coupling element 56 while are circumferentially spaced at a region coronal thereto of frusto-conical member 58. It will be appreciated that teeth 59 may be configured in any other desired fashion.

Abutment 69 has a varying shape in medial view, and the appearance of the abutment or of a dental structure attached thereto can be significantly changed when rotated about the axis of abutment 6. When abutment 69 is being intraorally adjusted, each recessed element 66 slides over a tooth 59 until being disposed at a desired angular position. Contact element 67 of abutment 69 is then adhesively connected to frusto-conical member 58 of coupling element 56 after abutment 69 is disposed at the desired angular position.

Teeth 59 and recessed elements 66 are suitably configured such that the wall of a recessed element will abut a tooth when abutment 69 is subjected to normal masticatory forces that cause slight rotation of the abutment relative to the coupling member, to prevent addition rotation. A recessed element 66 will slide over teeth 59 when a manual force of a magnitude much greater than that of normal masticatory forces is applied to the abutment.

Other angular displacement preventing means may be employed as well.

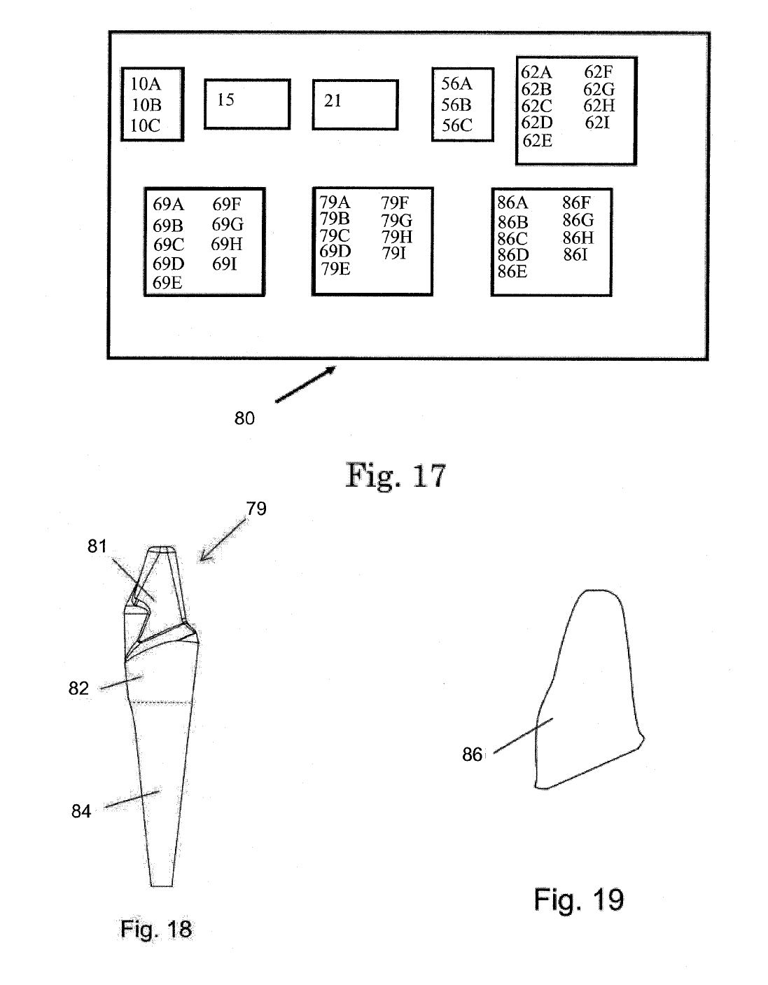

In operation, a dental practitioner is equipped with a kit 80 schematically illustrated in FIG. 17 when a patient in need of an implantation procedure is being treated. Kit 80 contains, for example, at least one interface element 21, a plurality of differently sized coupling elements 56A-C, a plurality of abutments 69A-I providing a different angulation for each of the differently sized coupling elements, a plurality of copings 62A-I providing a coping for each of the abutments, a plurality of extraction socket measuring tools 10A-C, protractor tool 15, a plurality of analogs 79A-I, and a plurality of temporary crown forms 86A-I. Alternatively, each of the plurality of coupling elements may be a combined member that is produced extraorally with the interface element. All of these components are prefabricated, and are preferably individually and sterilely wrapped.

Following the implantation procedure, whether being an immediate loading procedure or a two step procedure whereby cortical demineralized freeze dried bone or synthetic bone is added to prevent bone resorption, the dental practitioner measures the collar height and lateral dimension of the extraction socket that has been formed in the gingiva as a result of the implantation procedure by means of measuring tools 10A-C, and then measures the angulation of neighboring dental structures with respect to a frontal plane by means of protractor tool 15. After the intraoral dimensions have been measured, a suitable coupling element and abutment corresponding to the measured dimensions are selected. The selected abutment has an angulation no greater than that of the neighboring dental structures.

In order to allow the abutment assembly to be secured to the implant, the interface element is first inserted within the interior of the implant and its annular projection 24 (FIG. 3) is positioned so that it will be supported by the coronal end of the implant. If the coupling element is a component which is separate from the interface element, the coronal surface of barrel 23 and projection 24 of the interface element are adhesively connected to the coupling element such that member 27 of the latter projects coronally from the implant.

The selected abutment is then positioned in contact with the selected coupling element. The dental practitioner compares the selected abutment to the neighboring dental structures. If the angulation of the abutment with respect to a medial plane significantly differs from neighboring dental structures, the abutment is simply rotated about the implant axis until a substantially uniform angulation with respect to a medial plane is achieved. The abutment, while maintaining its new angular position, is then separated from the coupling element, whereupon an adhesive agent is applied so that the two will be adhesively connected.

A coping corresponding to the selected abutment is fit over the abutment. If the angulation of the selected abutment is less than that of the neighboring dental structures, the coping is manually built up with dental porcelain compatible with zirconia to provide a substantially uniform angulation with respect to a frontal plane. Material can be removed from the coronal portion of the selected coping between coronal surface 64 of the coping and coronal surface 49 of the abutment (FIG. 10) if not aligned with the gingival margin or if the selected coping protrudes from the neighboring dental structures.

A negative impression of the dentition is then made by placing a tray filled with impression material in the patient's mouth and having the patient bite into the impression material to form depressions. After the impression material has set, the tray is removed from the patient's mouth while the coping which has been separated from the abutment is imbedded within the impression material. A demo die corresponding to the shape of the selected coping is inserted into the interior of the coping. A master model constituting a positive replica of the dentition is produced by pouring molding material such as die stone into the depressions of the impression.

A typical demo die 79 is illustrated in FIG. 18. Demo die 79 has an abutment portion 81 that has the same shape and size as the selected abutment, an implant portion 84, and an intermediate portion 82 extending from the implant portion to the abutment portion.

A master model has been made heretofore by connecting a transfer device having an apical threaded portion to the implant, in order to replicate the spatial position of the implant, the impression is taken, an analog having a configuration which is complementary to the implant is connected to the impression and to the transfer device extraorally, and then the molding material is poured in order to produce the master model. At times when the extraction socket is relatively deep, the dental practitioner has difficulty in removing the analog from the model due to the depth of the replicated socket. Wax is often applied around the transfer device in order to facilitate its removal from the model, even though it is not possible in all situations as described, leading to an imperfect fit of the abutment made from the model due to the non-uniform layer of applied wax. The use of demo die 79 of the present invention is advantageous with respect to prior art replication methods in that it is easily removable from the master model and provides a perfect replication of the dimensions of extraction socket. Thus the need of a transfer device and analog is precluded.

After the coping has been separated from the abutment in order to produce the impression, a temporary crown form 86 shown in FIG. 19 is fit over the abutment.

Temporary crown form 86 made from polycarbonate has the same size and shape as the selected coping, and is built up with various layers made of porcelain powder having different shades to achieve the proper angulation as well as to emulate the natural translucency of the tooth enamel.

As may be appreciated by the foregoing description, use of the abutment assembly of the present invention reduces the waiting time of the patient since all of the aforementioned operations may be performed in a single session as well as providing good and accurate dentition.

In another embodiment, the abutment assembly according to any of the embodiments described hereinabove is receivable in a novel implant having a square shaped seat. A male element of an abutment assembly receivable in a square shaped seat has a considerably thicker wall surrounding the cavity through which the main screw passes than the wall of an abutment that is receivable in a prior art hex shaped seat, to prevent lateral masticatory forces from being transmitted to the main screw. An implant having a square shaped seat further provides a very small clearance between the abutment assembly of as little as 3 microns to prevent microbial infiltration.

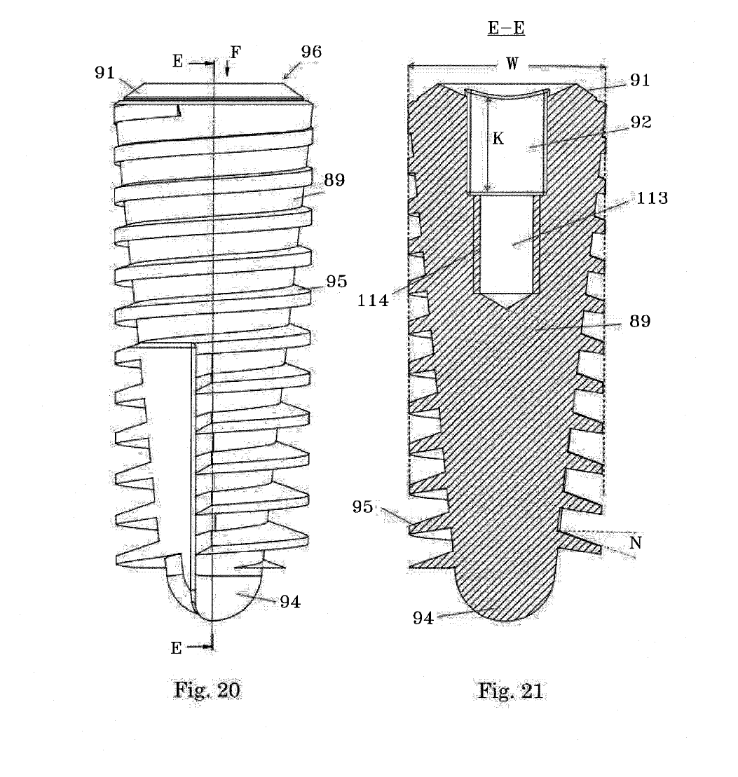

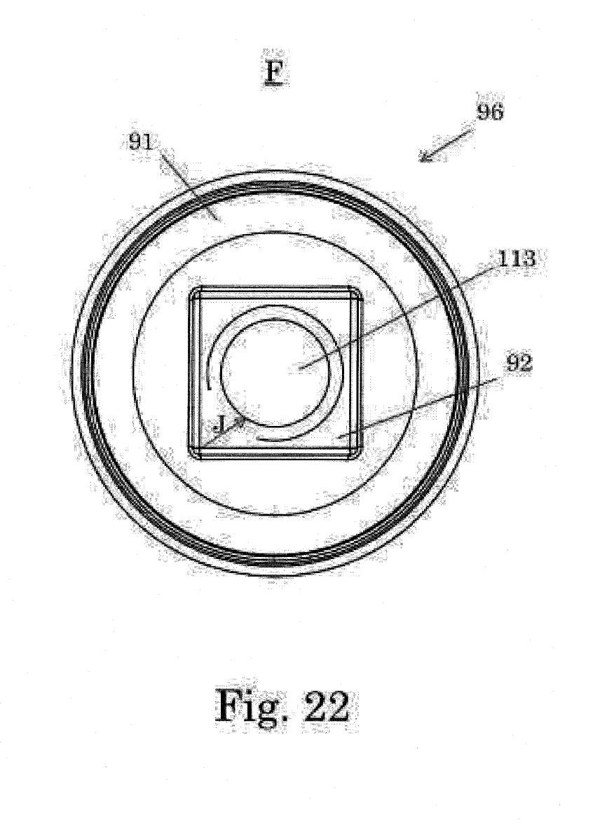

FIG. 20 illustrates an implant 96 for use in replacing anterior teeth. Implant 96 has a core 89 that is gradually reduced in diameter from a coronal neck 91 at which the core diameter is slightly greater than the neck diameter to an apical end 94, which may rounded as shown, or alternatively may be flat. Spiral threads 95 having an increased width in the apical direction protrude radially from core 89.

As shown in FIG. 21, which is a medial cross sectional view of implant 96, threads 95 are arranged such that the combined width of core 89 and of a thread at a given implant depth defines a uniform implant width W that is substantially equal to the implant width at any other implant depth between neck 91 and apical end 94. Large width, apically disposed threads facilitate anchorage of implant 96 into cancellous bone, which is relatively soft bone tissue enclosed by relatively hard cortical bone. Providing implant 96 with a uniform combined width W simplifies the implantation procedure, without need of a bone tap.

Threads 95 are preferably disposed at an angle N pointing apically with respect to a transverse plane, in order to induce increased bone density and osseointegration in the vicinity of threads 95 as a result of the pressure applied thereby onto the adjacent bone tissue. Angle N may range from 15-25 degrees, and preferably 17-22 degrees, e.g. 19.5 degrees. Threads 95 may have a uniform pitch, or alternatively, the pitch may vary.

Square shaped seat 92, which is shown in plan view in FIG. 22, is accessible to the abutment assembly via the interior of neck 91. A cavity 113 having internal threading 114 engageable with threading 34 of main screw 33 (FIG. 3) extends apically from, and has a smaller width than, seat 92. The width J of seat 92 that is unoccupied by the main screw, corresponding to a maximum abutment wall thickness ranges from 2.2-2.5 mm, a value much greater than the maximum wall thickness enabled by a hex shaped seat. The ability to absorb lateral masticatory forces is also facilitated by virtue of a relatively deep seat 92 having a depth K ranging from 1.8-3.6 mm.

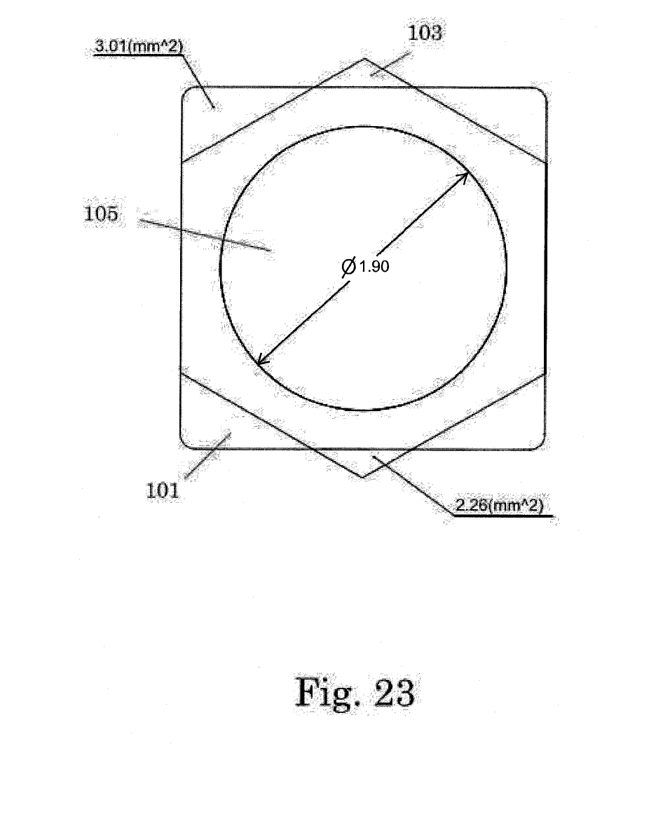

FIG. 23 illustrates the improved force absorption ability of a square shaped abutment 101 relative to a hex shaped abutment 103, each of which being shown in cross section. Both abutments 101 and 103 are bored with an identical screw receivable cavity 105 and are superimposed one on top of the other while the bores are aligned such that two sides of square shaped abutment 101 are coincident with two corresponding sides of square shaped abutment 101 and only two small corner portions of abutment 103 protrude outwardly from the contour of abutment 101. As can be clearly seen, the enclosed area between the outer contour of abutment 101 and the outer contour of cavity 105 is considerably greater and more conducive to absorbing transmitted forces than the enclosed area between the outer contour of abutment 103 and the outer contour of cavity 105. When each side of abutment 101 has a length of 2.42 mm, each side of abutment 103 has a length of 1.4 mm, and cavity 105 has a diameter of 1.9 mm, the enclosed area of hex shaped abutment 103 is only 2.26 m² while the enclosed area of square shaped abutment 101 is 3.01 m².

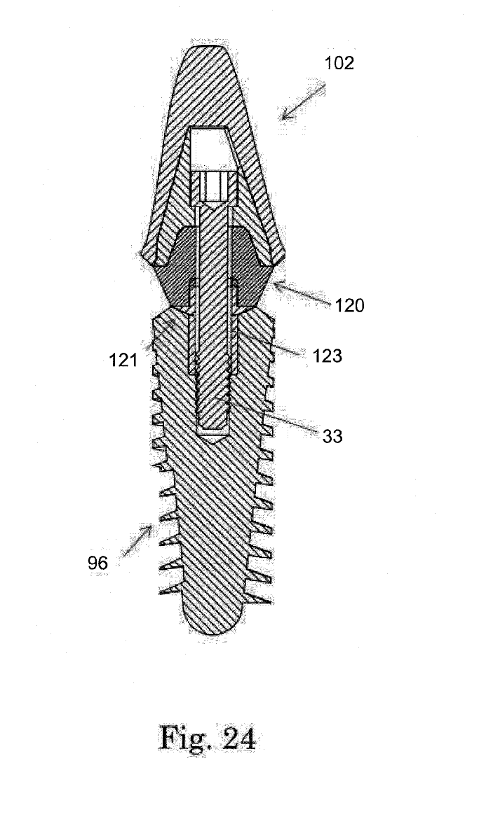

FIG. 24 illustrates an implant assembly 102 comprising implant 96 and abutment assembly 120 having a 0 degree angulation with respect to a frontal plane coinciding with the implant axis. Abutment assembly 120 is similar to abutment assembly 20 of FIG. 1, with the exception that barrel 123 of interface element 121 is considerably longer than barrel 23 of interface element 21 (FIG. 3) and is square shaped. By virtue of the square shaped barrel 123, lateral masticatory forces transmitted through core 89 of implant 96 will be substantially isolated from main screw 33.

It will be appreciated that the abutment assembly may be of any other desired angulation with respect to a frontal plane or of any other configuration insofar as the protruding element receivable in the seat is squared shaped.

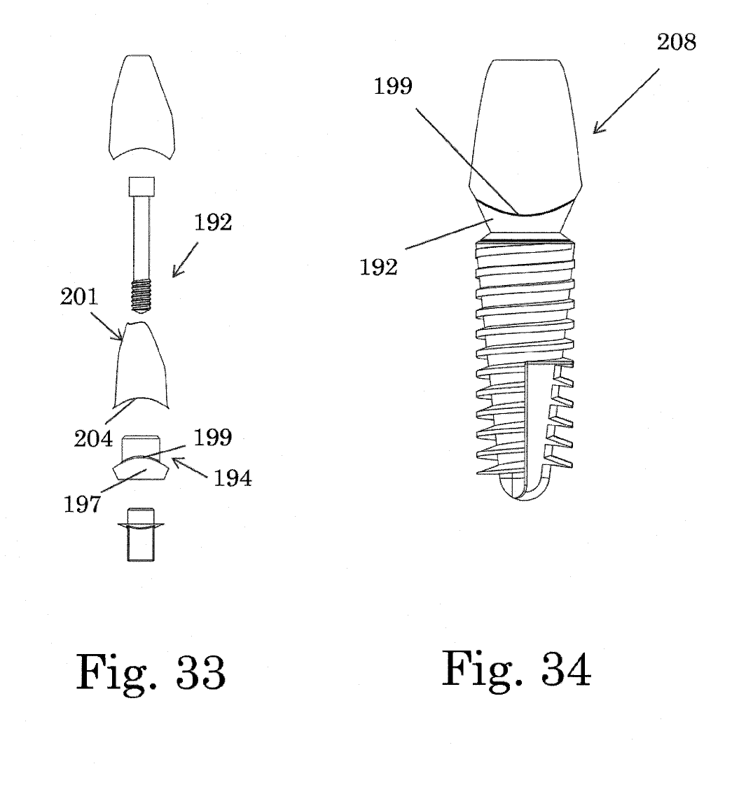

An abutment assembly 192, as shown in FIG. 33, may comprise a coupling element 194 that has an apical member 197 formed with a curved anatomically shaped coronal surface 199. Curved coronal surface 199 of apical member 197 adapted to be in abutting relation with complementary surface 204 of abutment 201 has the curvature of the gingival margin, to provide an esthetic appearance of a natural tooth. FIG. 34 shows a frontal view of an implant assembly 208 that comprises abutment assembly 192, curved surface 199 being indicated.

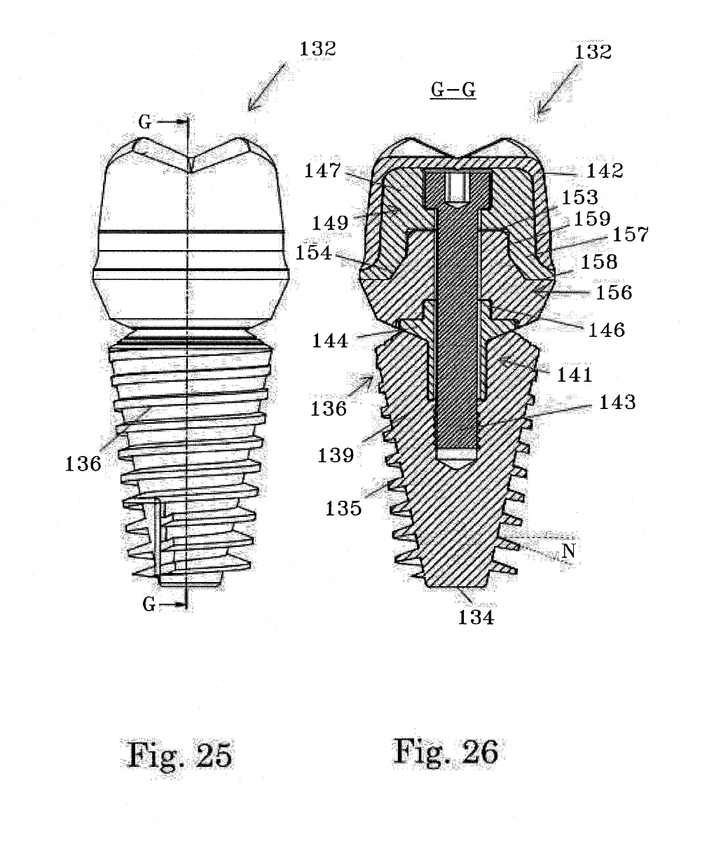

FIGS. 25 and 26 illustrate an implant assembly 132 for use in replacing posterior teeth, e.g. molars. Implant assembly 132 comprises an implant 136 having a square shaped seat and threads 135 inclined at angle N; however, the length of implant 136 is less than that of implant 96 of FIG. 21, to avoid puncturing the sinus cavity or a nerve in the vicinity of the extraction site. In order to compensate for the reduced length of implant 132 and to provide the needed anchorage, core 139 has an increased thickness that slopes at a larger angle to flat apical end 134 than core 89 of implant 96. Also, main screw 143 as well as annular projection 144 and coronally protruding portion 146 of interface element 141 are thickened, and abutment 149 has a widened body 147.

Coupling element 156 has a sloped surface 154 that extends from outer transverse surface 158 to surface 159, which is substantially perpendicular to transverse coronal end 153. Surfaces 154 and 159 are in abutting relation with contact element 157 of abutment 149.

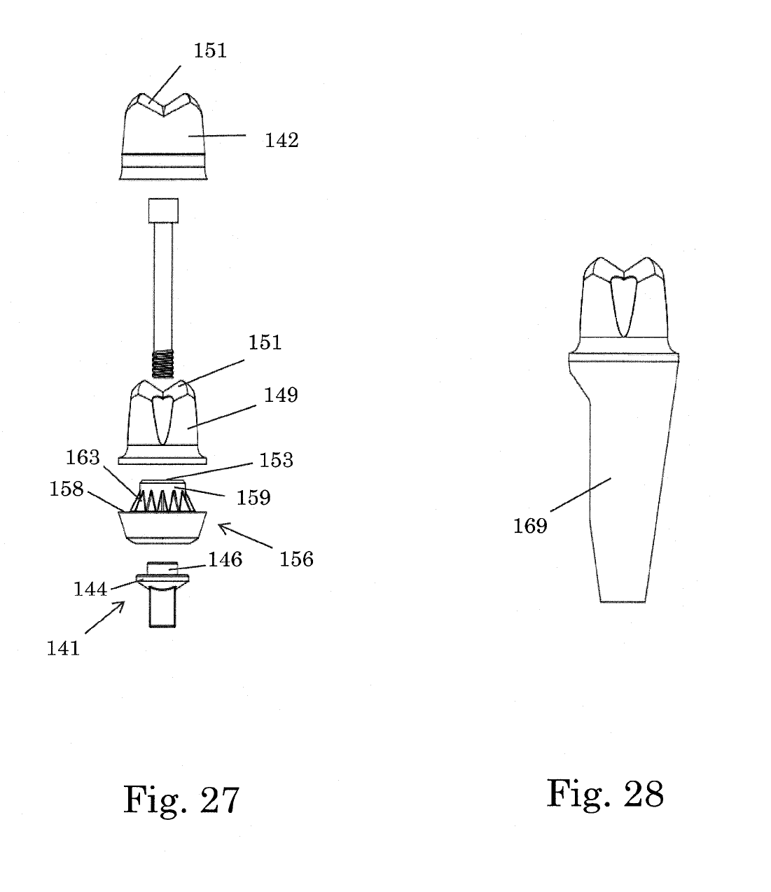

FIG. 27 illustrates an exploded view of an abutment assembly that may be used in conjunction with implant 136. Both abutment 149 and coping 142 have oblique coronal surfaces 151 that are shaped similarly to the cusps of a molar tooth or of a molar crown.

Coupling element 156 is formed with a plurality of circumferentially spaced triangular teeth 163 that protrude radially outwardly from sloped surface 154 (FIG. 26), extending coronally until the apical edge of surface 159. Each tooth 163 is adapted to be engaged with complementary circumferentially spaced recessed elements formed in hollow contact element 157 of abutment 149, in order to prevent unwanted rotation and loosening of abutment 149 during mastication.

FIG. 28 illustrates a demo die 169 that has the same shape as coping 142 of FIG. 27 and is insertable therewithin, to facilitate production of a master model.

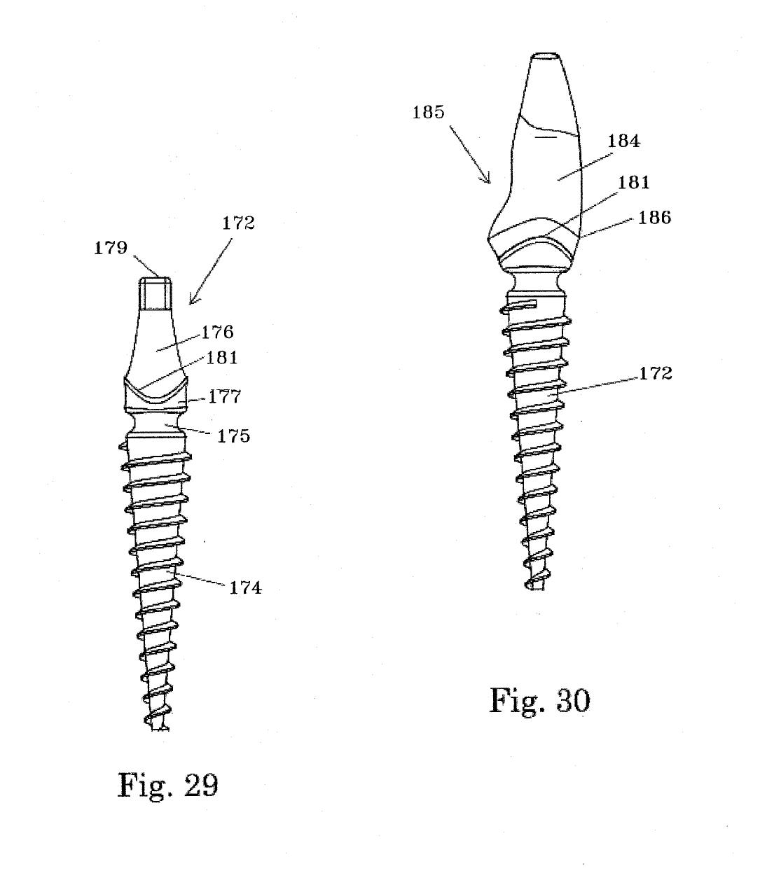

FIG. 29 illustrates another embodiment of the invention wherein a one piece implant-abutment fixture 172 is employed in lieu of an extracted anterior tooth. Fixture 172 comprises implant portion 174, anatomically shaped abutment portion 176, and reduced diameter neck portion 175 intermediate to implant portion 174 and abutment portion 176, to assist in bending and positioning fixture 172.

Abutment portion 176 has a thickened element 177 adjacent to neck portion 175, from which abutment portion 176 tapers to thin, transversally shaped coronal end 179. A curved border 181 delimits thickened element 177.

FIG. 30 illustrates a frontal view of implant assembly 185 comprising fixture 172 and coping 184 fitted thereon, extending until border 181. As shown, border 181 has the curvature of the gingival margin, to provide the appearance of a natural tooth. By virtue of the sleek, anatomically shaped abutment portion, two or more implant assemblies can be placed in abutting relation, for example at distal end 186, and additionally may be cleaned. Prior art abutment assemblies, in contrast, are excessively wide and some material has to be removed therefrom in order to accommodate an adjacent assembly.

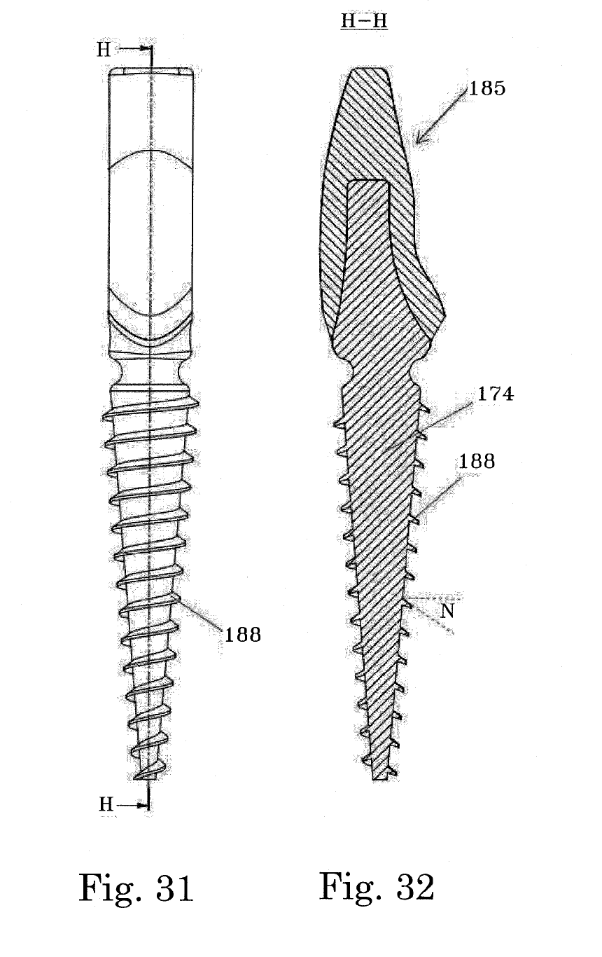

FIG. 31 illustrates a medial view of implant assembly 185 and FIG. 32 illustrates a frontal cross sectional view thereof. Implant portion 174 is shown to have oblique spiral threads 188 that point apically with respect to a transverse plane at an angle N.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. An abutment assembly for dental implants comprising only prefabricated components, said abutment assembly comprising an interface element insertable within the interior of, and positionable in abutting relation with, an endosseous implant, a coupling element connected to said interface element, an abutment engageable with said coupling element and coronally spaced from said interface element, and a screw threadedly engageable with said implant and securable to said abutment, wherein one or more dimensions of said coupling element are selectable in accordance with dimensions of an extraction socket associated with said implant and a disposition of said abutment with respect to said implant is intraorally adjustable.

2. The abutment assembly according to claim 1, wherein the abutment is rotatable with respect to the coupling element and about an implant axis when being adjusted intraorally.

3. The abutment assembly according to claim 2, wherein the abutment is adhesively connectable to the coupling element after being adjusted intraorally.

4. The abutment assembly according to claim 1, further comprising a dental structure which is releasably attachable to, and similarly configured as, a coronal end of the abutment.

5. The abutment assembly according to claim 4, wherein the dental structure is a prefabricated coping.

6. The abutment assembly according to claim 4, wherein the dental structure is a temporary or permanent crown.

7. The abutment assembly according to claim 1, wherein the screw is receivable in a central apically extending cavity formed in the abutment, said cavity coinciding with a central cavity formed in the interface element and in the coupling element.

8. The abutment assembly according to claim 7, wherein the cavity formed in the abutment is also formed with a shoulder for contacting and limiting the travel of a coronal head of the screw while apical threading of the screw is being engaged with internal threading of the implant.

9. The abutment assembly according to claim 7, wherein a central annular member of the coupling element protruding coronally from an apical member thereof is receivable in a complementary recess of the abutment, the abutment being rotatable about the central annular member of the coupling element when being adjusted intraorally.

10. The abutment assembly according to claim 9, wherein a height of the coupling element from a coronal edge of the central annular member to an apical edge of the apical member thereof is selected to be substantially equal to the depth of the extraction socket.

11. The abutment assembly according to claim 2, wherein an angulation of a coronal portion of the abutment with respect to a medial plane is substantially equal to that of neighboring dental structures after the abutment has been adjusted intraorally.

12. The abutment assembly according to claim 1, wherein an angulation of the abutment with respect to a frontal plane is selectable.

13. The abutment assembly according to claim 1, wherein the coupling element is adhesively connected to the interface element.

14. The abutment assembly according to claim 1, wherein the coupling element is fused to, or is integral with, the interface element.

15. The abutment assembly according to claim 1, wherein the coupling element is made of zirconia.

16. The abutment assembly according to claim 1, wherein the interface element is made of titanium or a titanium alloy.

17. The abutment assembly according to claim 1, wherein a protruding element of the interface element receivable in a complementary seat of the implant is square shaped.

18. The abutment assembly according to claim 1, wherein a protruding element of the interface element receivable in a complementary seat of the implant is hex shaped.

19. A kit, comprising the prefabricated components of the abutment assembly of claim 1 including a plurality of differently dimensioned coupling elements and abutments.

20. The kit according to claim 19, further comprising a plurality of copings, each of which is releasably attachable to, and similarly configured as, a coronal end of a corresponding abutment.

21. The kit according to claim 19, further comprising one or more measuring tools for measuring a corresponding intraoral dimension and for selecting thereby one of the plurality of differently dimensioned coupling elements and one of the plurality of differently dimensioned abutments.

22. The kit according to claim 20, further comprising one or more demo dies, each of which comprising an abutment portion having the same size and shape as the coping and being insertable therewithin to facilitate production of a master model, an implant portion, and an intermediate portion extending from said implant portion to said abutment portion.

23. A dental implant, comprising a core that is gradually reduced in diameter from a coronal portion to an apical end and spiral threads protruding radially from said core, wherein said threads are obliquely disposed such that they point apically at an angle with respect to a transverse plane ranging from 15 to 25 degrees, in order to induce increased bone density and osseointegration in the vicinity of said threads as a result of pressure applied thereby onto the adjacent bone tissue.

24. The dental implant according to claim 23, wherein the threads are arranged such that a combined width of the core and of a thread at a given implant depth defines a uniform implant width that is substantially equal to the implant width at any other implant depth between the coronal portion and the apical end, for facilitating anchorage into cancellous bone.

25. The dental implant according to claim 23, which has a square shaped seat in which is receivable a complementary protruding element of an abutment, said seat being accessible to said protruding element via the interior of the coronal portion.

26. The dental implant according to claim 25, which is formed with a cavity having internal threading for engagement with threading of a screw for securing the abutment to the implant, said cavity extending apically from, and having a smaller width than, the seat.

27. The dental implant according to claim 23, wherein the threads point apically at an angle with respect to a transverse plane ranging from 17 to 22 degrees.
